(19) United States
(12) Patent Application Publication
(10) Pub. No.: US 2015/0310327 A1
(43) Pub. Date: Oct. 29, 2015

(54) RFID READER AND TRANSPONDERS

(71) Applicant: REED LICENSING PTY LTD, Breakwater, Victoria (AU)

(72) Inventors: Nemai Karmakar, Wheelers Hill, Victoria (AU); Md Aminul Islam, Clayton, Victoria (AU); Yixian Yap, Oakleigh East, Victoria (AU); Akm Azad, Glen Waverley, Victoria (AU); Klaus Lorentschitsch, Murrumbeena, Victoria (AU)

(21) Appl. No.: 14/649,529

(22) PCT Filed: Dec. 4, 2013
(86) PCT No.: PCT/AU2013/001409

§ 371 Date: Jun. 3, 2015

(30) Foreign Application Priority Data
Dec. 4, 2012 (AU) 2012905291
Apr. 30, 2013 (AU) 2013901509

(51) Int. Cl. G06K 19/077; H01Q 1/22; G06K 7/10

(52) U.S. Cl. CPC G06K 19/07773; G06K 7/10356; H01Q 1/2225; H01Q 1/2216

(57) ABSTRACT

A passive and chipless RFID transponder comprising: a substrate; and at least one planar patch on the substrate, the patch including a slot resonator of with radial conductive strips disposed at points around the slot resonator.

### FIELD

The present invention relates to a radio frequency identification (RFID) reader, and RFID transponders or tags that may be read by the reader.

### BACKGROUND

Radio frequency identification (RFID) systems use radio frequency (RF) signals to excite and extract encoded identification data from remote RFID transponders or tags. The systems include one or more RFID tags, where data is encoded, affixed to items or assets associated with the identification data, and a RFID reader used for extracting the encoded data from RF signals returned by the tags. RFID tags are used to replace barcodes due to their long reading range, ability to read without line of sight, and automated identification and tracking. The scope of application of RFID systems is expanding, but they still tend not to be used in low cost applications because of their cost compared to barcodes. Accordingly, research effort has focused on developing chipless printable RFID tags. which can be used like barcodes. However, the removal of the microprocessor or microcontroller chip from the tag makes it difficult to encode high numbers of bits within a small tag.

Printable chipless RFID tags have been developed using time domain, frequency domain, phase domain and image based encoding techniques. However, a compact fully printable chipless tag with a high data capacity, such as 64 bits, has not been developed. Image based tags in particular are still experimental and need costly submicron level printing. Frequency domain based tags have higher data density than time domain based tags but none can encode 64 bits within a credit card sized area. For most of the designs, the size of the tag increases linearly with the number of bits because of the addition of extra resonators. Also, 64 bits has not been encoded practically within a UWB frequency band using band stop resonators, and most of the designs require perfect alignment with the antennas of the RFID reader for measurement.

It is desired to address the above or at least provide a useful alternative.

### SUMMARY

In accordance with the present invention there is provided a passive and chipless RFID transponder comprising:

a substrate; and

at least one planar patch on the substrate, said patch including a slot resonator of with radial conductive strips disposed at points around the slot resonator.

The present invention also provides a passive and chipless RFID transponder comprising:

a substrate; and

at least one planar patch on the substrate, said patch including parallel pairs of horizontal slot resonators in opposing quadrants and having lengths Lᵢ, i=1−n. that decrease towards the centre of the patch; and parallel pairs of vertical slot resonators in opposing quadrants and having lengths Wᵢ, i=1−n, that decrease towards the centre of the patch.

The present invention also provides a passive and chipless RFID transponder comprising:

a substrate; and

a plurality of planar antennas with respective selected resonant frequencies. wherein each antenna includes a first portion in conductive communication with both a second portion and a third portion, and wherein the second portion and the third portion arc separated by a non-conductive slot.

The present invention also provides an RFID reader, including:

a transmit antenna for transmitting RF interrogation signals to a passive and chipless RFID transponder;

a receive antenna for receiving backscattered signals in response from the RFID transponder;

an RF module including an RF transmitter for generating the RF interrogation signals for the transmit antenna and an RF receiver for amplifying and down converting the signals received by the receive antenna; and

a digital Module including a digital controller for controlling the RF transmitter and a digital signal processor (DSP) for processing the down converted signals from the RF receiver to extract a unique identification (ID) code of the RFID transponder.

### DESCRIPTION OF THE DRAWINGS

Embodiments of the present invention are hereinafter described, by way of example only. with reference to the accompanying drawings, wherein:

FIG. 1 is a plan view of a first embodiment of an RFID tag;

FIG. 2 is a plan view of a second embodiment of an RFID tag;

FIG. 3 is a plan view of a third embodiment of an RFID tag;

FIG. 4 is a plan view of a fourth embodiment of an RFID tag;

FIG. 5A is a plan view of a fifth embodiment of an RFID tag;

FIG. 5B is a plan view of one antenna of the tag in FIG. 5A;

FIG. 5C is a plan view of an array of four antennas in the tag in FIG. 5A;

FIG. 6 is a block diagram of an embodiment of an RFID reader and tag;

FIG. 7 is a block diagram of the RFID reader;

FIG. 8 is a diagram of the frequency sub-bands used by the RFID reader:

FIG. 9 is a diagram of frequency responses obtained from different versions of the RFID tag of FIG. 3;

FIG. 10 is a diagram of the frequency responses obtained from another version of the RFID tag of FIG. 3 at different orientations; and

FIG. 11 is a diagram of the relative and normalised frequency shifts of the responses obtained from the tag of FIG. 10.

### DETAILED DESCRIPTION

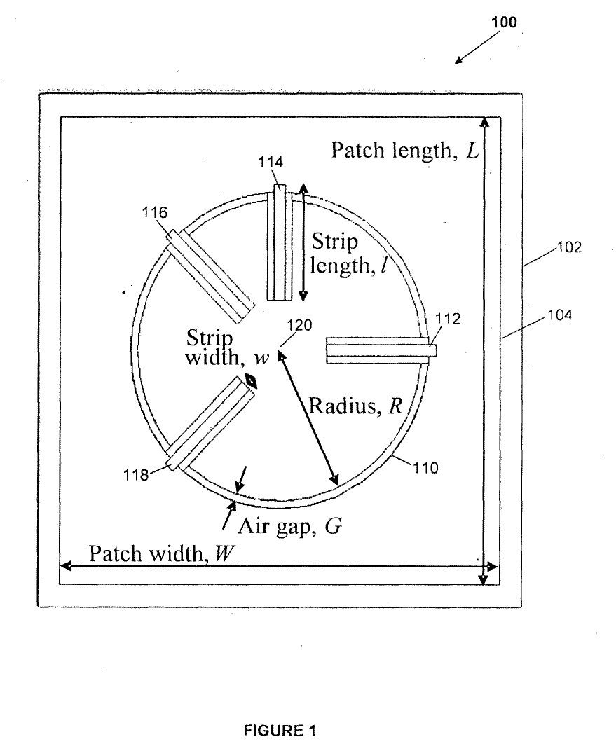

Passive and chipless (i.e. without any active circuitry, such as a microcontroller or microprocessor) radio frequency identification (RFID) transponders or tags 100, 200, 300. 400 and 500 are shown in FIGS. 1 to 4 and 5A. The tags each include a non-conductive or dielectric substrate 102, 402, 504 which may include an adhesive layer for affixing the tags to items or assets. A rectangular conductive or metallic (such as copper) planar patch 104, 204, 304, 506 is printed or deposited on the substrate 102, 402. The transponders each store a unique identification code that is obtained from the time, frequency and/or phase data of the backscattered radio frequency signals when the transponder 100, 200, 300, 400 or 500 is excited by transmitted radio frequency interrogation signals produced by an RFID reader 600. The transmitted signals have frequencies within a bandwidth of 22 to 26.5 GHz. The patches 104, 204, 304, 504 of the transponders each include air gap slots, as discussed below, that radiate at resonant frequencies to produce backscattered signals representing the stored identification code.

A first RFID tag 100 has a metallic patch 104 that is rectangular (or square) with a width W and length L. The patch 100 has a central circular slot 110 where the conductive material is omitted, by being not printed or cut, so as to provide the slot 110 with an air gap G. The inner radius of the circular slot is R. The air gap of the slot 110 is not continuous. as conductive strips or stubs 112, 114, 116, 118, having a length l and width w, are disposed at points on the circumference of the slot 110 so as to extend radially towards the centre of the patch 104 and the centre 120 of the circle defined by the circular slot 110. The radial conductive strips 112, 114, 116, 118 have an air gap of width G along their length, but not at their ends. The strips are placed at angular points on the circular slot 110, for example the strip 112 is placed at 90° , strip 118 at 225°, strip 116 at 315°. and strip 114 at 0° or 360°. The resonant frequency of the tag 100 is determined by adjusting the parameters W, L, G, R, w and l of the patch 104.

By symmetric placement of the circular slot 110 and the strips 112, 114, 116, 118, the operation of the tag 100 is made independent of the orientation of the patch 104. This means the tag could be excited by vertically and horizontally polarised radio frequency (RF) interrogation signals of the reader 600 and the response received by the reader 600 will be the same regardless of the orientation of the patch 104 compared to the transmit antennas 602, 604 of the reader 600. The patch 104 is symmetrical when the strips 112, 114, 116, 118 arranged symmetrically around a circular slot 110. This involves placing them opposite one another so pairs of strips are aligned. When the patch 104 is symmetrical the vertically and horizontally polarised backscattered signals are the same and resonate or not at the same frequency. The tag 100 is then only able to encode one hit in the frequency domain.

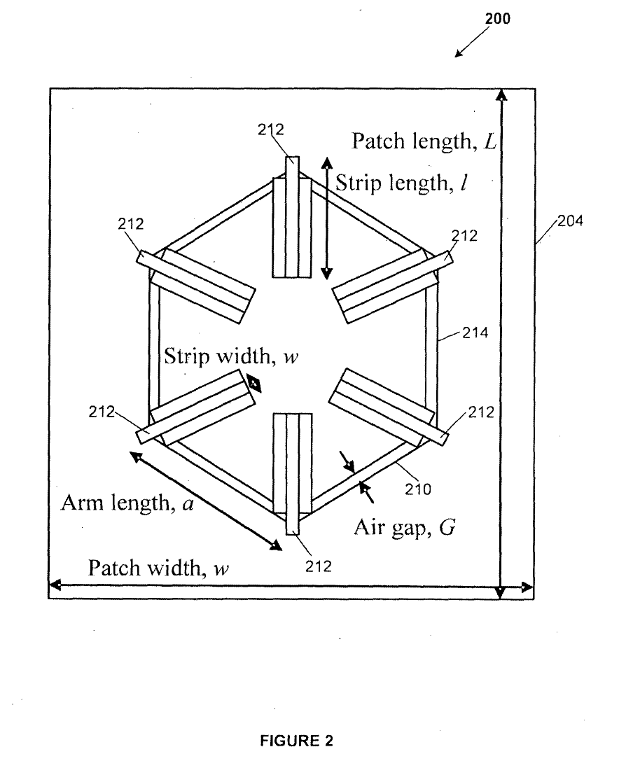

A second tag 200 has a patch 204 which is the same as the patch 104, except instead of a circular slot 110, a polygonal slot 210 with an air gap G is used. The patch 204 has the strips or stubs 212 of length l and width w placed so as to extend from the vertices of the polygonal slot 210. Between the vertices, the slot 210 has sides with an arm length a. Again, the resonant frequency of each patch 204 is determined by adjusting the parameters W, L, G, R, a, w and l of the tag 200. The response from the tag is again orientation independent if the slot 210 and the strips 212 are placed symmetrically, as shown in FIG. 2. The resolution of the orientation dependency increases by increasing the number of polygonal sides 214. For example, the slot 210 in FIG. 2 is hexagonal, but increasing it to a higher polygon and optimising the strip length l provides more symmetry and improved orientation independence. If the tag 100 is completely symmetric for full orientation independence, then like the tag 100, it is only able to encode 1 bit in the frequency domain.

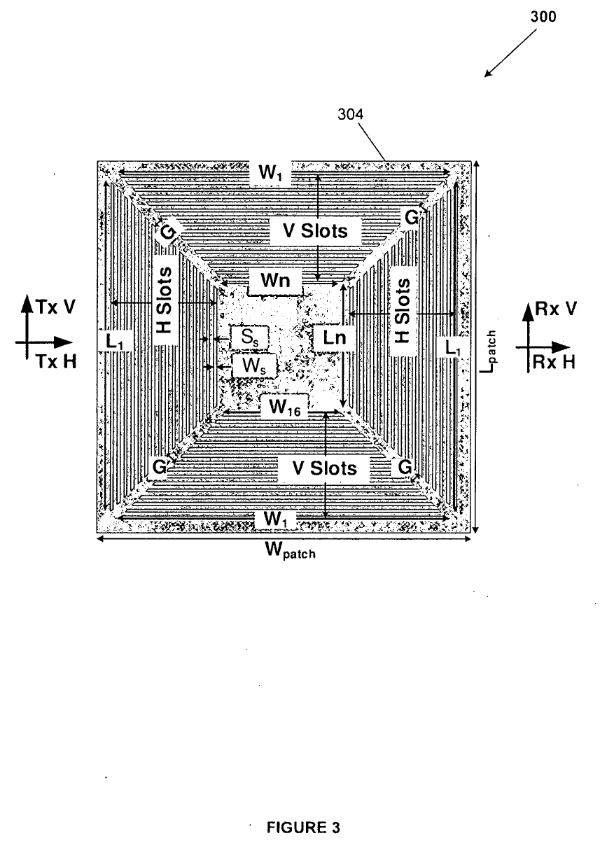

A third RFID tag 300, as shown in FIG. 3, has a patch 304 with a width W and a length L. The patch 304 has a number of vertical and horizontal air gap slots that are straight or “I” shaped and run parallel to respective sides of the patch. The resonator slots have a width or air gap Ws and are spaced from the adjacent slot by a gap Ss. The slots have different lengths so as to resonate at different frequencies and give a different response to depending on the polarisation of the transmitted interrogation signal. Horizontal slots, or H slots, are parallel and have lengths Lᵢ, i=1−n, that decrease towards the centre of the patch so there are two opposing or pairs of H slots of length L₁ that arc the longest and two opposing or pairs of slots of length Lₙ that are the shortest. The pairs of II slots occupy respective first and second opposing quadrants of the path 304. The H slots respond only to horizontally polarised transmitted signals. The vertical slots, or V slots, are also parallel, but perpendicular to the H slots and have lengths Wᵢ, i−1−n that decrease towards the centre of the patch 304. The longest pairs of W slots have a length W₁ and arc closer to the edge of the patch 304 and there are two slots of length W disposed closer to the centre of the patch. The ends of the H slots and V slots of equal length, or corresponding i, are separated by an equal gap of length G. The pairs of V slots occupy respective third and fourth opposing quadrants of the patch 304. The V slots only respond to a vertically polarised transmitted signal. As the responses for the V and H slots are independent of one another, the same frequency can be used twice to obtain a response from a respective pair of H slots of length Lᵢ and a respective pair of V slots of length Wᵢ. Accordingly, if n=16, one patch 304 can encode 32 bits of information or data.

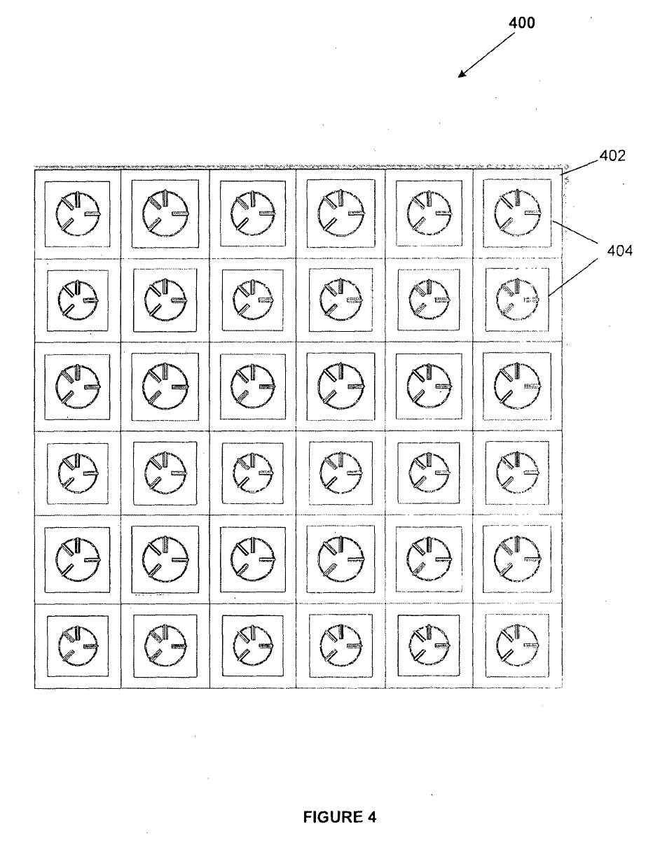

A fourth RFID tag 400 includes a dielectric substrate 402 on which an array of patch antennas 404 is printed or deposited. The patches 404 are symmetrically arranged so as to provide orientation independency. In the example of FIG. 4 the array is 6×6. so as to provide 36 patches 404. The patches 404 can be any one of the first or second patches 104 or 204 so as to increase information encoded in those patches by 36 times. For example, if the first and second patches 104 and 204 each encode a bit of information, the tag 400 would encode 36 bits of information. If the array was 8×8, then it would encode 64 bits of information. The patch 304 of the third tag 300 can be used to provide the patches 404, but the patch 304 is orientation sensitive and is a multi-bit patch. Accordingly, if the patch 304 is used to provide the patch 404, then the tag 400 should have a smaller array, such as a 2×2 array having four patches 304.

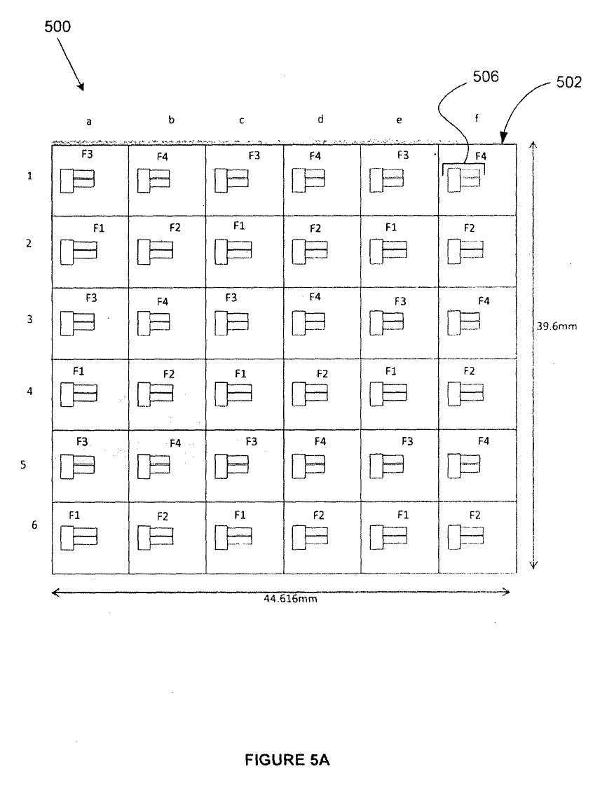

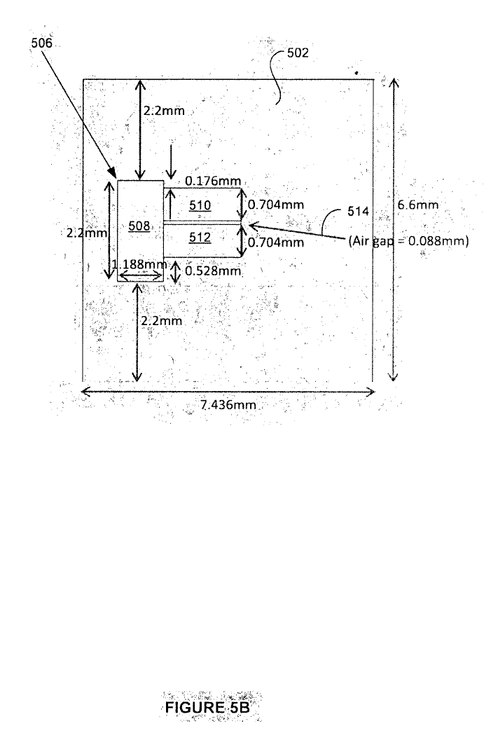

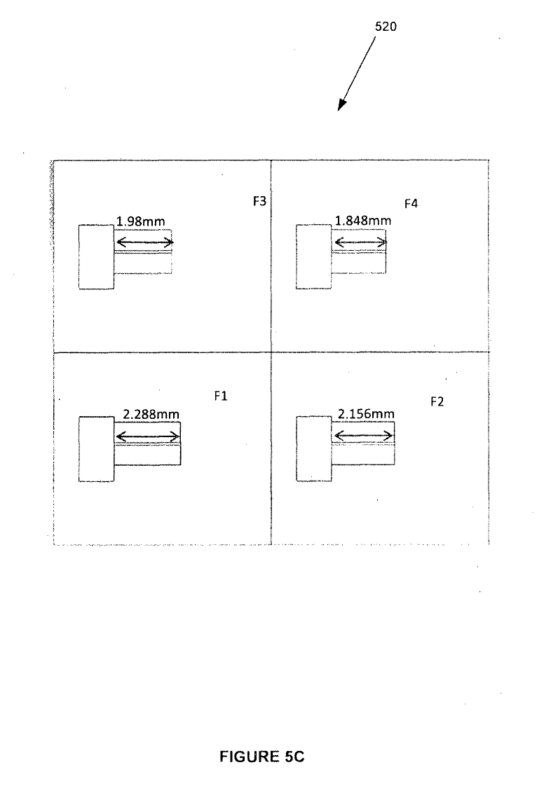

A fifth RFID tag 500 includes a dielectric substrate 502 on which an array of patch antennas 506 is printed or deposited, as shown in FIG. 5A. The substrate 502 can he a non conductive material, such as paper, and the antennas 506 can be printed using conductive material, e.g. via thermal transfer. Each antenna 506 includes a planar structure comprising three conductive portions, as shown in FIG. 5B: a first conductive portion 508 is planar and elongated in a first direction (e.g. forming a first rectangle); and a second portion 510 and a third portion 512 are planar and elongated (e.g. rectangles) in a second direction perpendicular to the first direction (e.g. forming second and third rectangles oriented perpendicular to the first rectangle). Furthermore, the second and third portions 510, 512 are parallel to each other, and in conductive communication with the first portion 508 (e.g. adjacent and connected to one side of the first portion 508). The second and third portions 510 and 512 are parallel and spaced by a slot 514 which is anon-conductive gap between the second and third portions forming an air gap. The antenna 506 is surrounded by non-conductive portions of the tag 500. The antennas 506 are printed on the dielectric substrate 502 at approximately regular intervals with spacings between the antennas 506 selected to substantially avoid electromagnetic interference between pairs of the antennas 506 which would interfere with the signals from the antennas 506. Each antenna 506 has a characteristic frequency determined by the dimensions and arrangements of the portions 508, 510, 512. The tag 400 includes antennas 506 with a plurality of different characteristic frequencies, e.g. at least one first antenna with a first characteristic frequency F₁, at least one second antenna with a second characteristic frequency F₂, at least one third antenna with a third characteristic frequency F₃, and at least one fourth antenna with a fourth characteristic frequency F₄. The tag 500 can be excited by circular polarised radiation from an antenna of the RFID reader 600, and each antenna 506 responds at its characteristic frequency. The characteristic frequency for each antenna 506 can be set by selecting the same dimensions for each antenna 506 except for the length of the second and fourth portions 510. 512, which can be varied to differ, and thus define the different characteristic frequencies of F₁, F₂, F₃ and F₄. An example of the dimensions of the antennas 506 are shown in FIGS. 5B and 5C with the following characteristic frequencies: F₁=21.84 GHz, F₂=23.28 GHz, F₃=24.52 GHz and F₄=26.34 GHz. A plurality of different antennas 506 with respective different characteristic frequencies can be arranged in a sub-array of elements (e.g. 4), thus representing a plurality of bits (e.g. 4 bits) which can be used to encode information in the tag 500. Once the numerical value of the tag has been decided, e.g. binary number “0101”, it can be determined which of the antennas 506 in the sub-array 520 are to be printed, e.g. the printed antennas could be F₂ and F₃ and the positions of F₁ and F₃ could be left blank (i.e. unprinted) to represent “0101”. The tag 500 includes a plurality of sub-arrays 520 to increase the signal strength from the tag 500, e.g. each sub-array defining the numerical value of the tag 500 can be repeated a plurality of times, as shown in FIG. 5A. The non-conductive slot 514 may comprise of a first gap portion having a first gap width between the second portion 510 and the third portion 510, and a second gap portion joining the first gap portion and having a second gap width between the second portion 510 and the third portion 512. Variations in the gap width can be used to define different resonant frequencies.

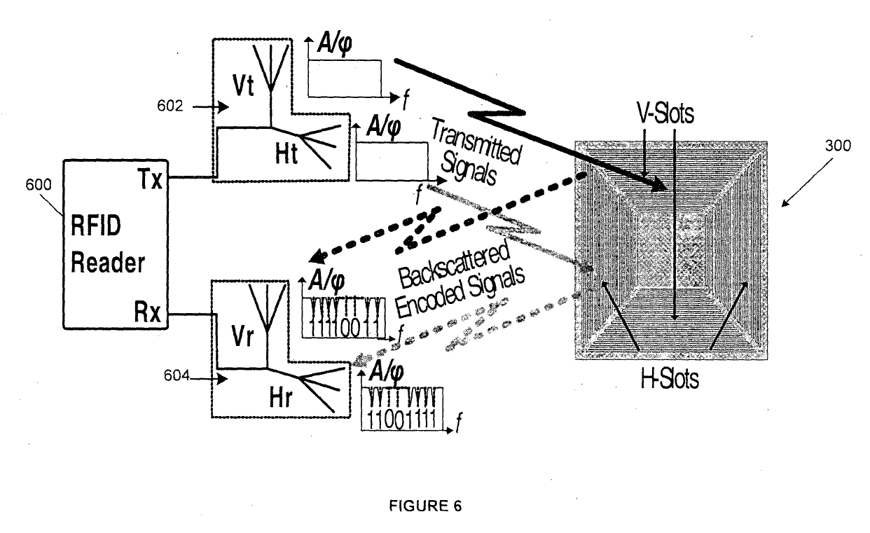

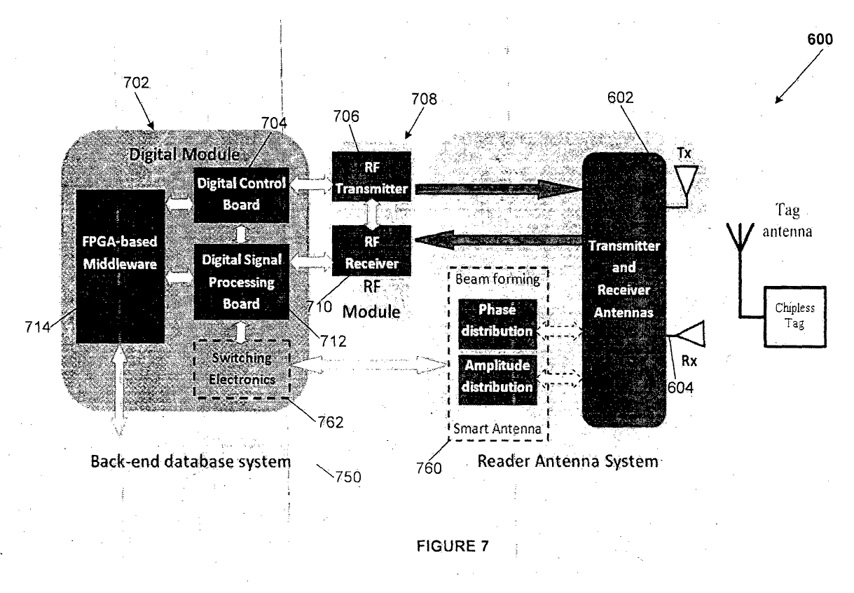

The RFID tags 100, 200, 300, 400, 500 are excited by a dual polarised transmitter antenna (TX) 602 of the RFID reader 600, as shown in FIG. 6. The RFID tags are excited and respond by producing frequency encoded backscattered signals that are received by a dual polarised receiver antenna (RX) 604. The RFID reader 600, as shown in FIG. 7, includes a digital control module 702 with a digital control board 704 that generates voltage controlled oscillator (VCO) signals to drive a radio frequency (RF) transmitter 706 of an RF module 708. The RF transmitter 706 generates the interrogation signals for transmission by the transmit antenna 602. The backscattered signals from the tags are received by the receiver antenna 604 and passed to an RF receiver 710 of the RF module 708. The RF receiver module 710 processes the received backscattered signals by performing low noise amplification and mixing so as to down convert to a lower intermediate frequency band. The processed intermediate frequency signal is output to a digital signal processor (DSP) 712 of the digital module 702. The DSP 712 samples the received signal and executes signal processing algorithms under the control of embedded computer program (middleware) code of a field programmable gate array (FPGA) 714 of the digital module 702. The code executes signal processing to remove noise and identify or extract the data encoded in the read tag, which represents the tag's identification.

The digital module 702 of the reader 600 communicates with and is controlled by a back-end database system 750 which executes a reader control application to generate control commands for the module 702 and receive, store and process tag identification data associated with the items or assets on which the tags are placed. The database system 750 is a computer system, such as produced by IBM Corporation or Apple Inc., having microprocessor circuitry, computer readable memory, and a data communications connection with the reader 600.

To improve the RF sensitivity of the reader 600, the RF module 708 uses precise RF components and an advanced receiver architecture that exploits techniques such as 1/Q modulation. With improved RF sensitivity, the reader 600 is able to detect and receive weak backscattered signals. This is also assisted by improving the antenna gain of the reader 600 by adjusting the antenna designs, such as providing a broadband patch antenna array for the antennas 602 and 604. The higher gain of the reader transmit antenna 602 increases the transmitted power directed and focussed towards the tag, and the higher gain of the reader receive antenna 604 further enhances any weak received signals from the tag, thereby improving the signal to noise plus interference ratio (SNIR).

The reader 600 is also able to include beam forming smart antennas 760 for the transmit and receive antennas 602 and 604 so that the transmitted and received signals of the antennas can be beam steered electronically by varying their phase and amplitude distribution. Varying the beamwidth of the transmitted and received signals provides spatial diversity so that tags placed side by side on assets can be discriminated and read as the beam is steered. The smart antenna array 760 is controlled by switching electronics 762 that in turn is controlled by the DSP 712. Beam forming smart antennas 760 also further improve the SN1R by focussing the transmitted signal energy and the antennas 602 and 604 towards the direction of the tag and any nulls are directed towards sources of interference.

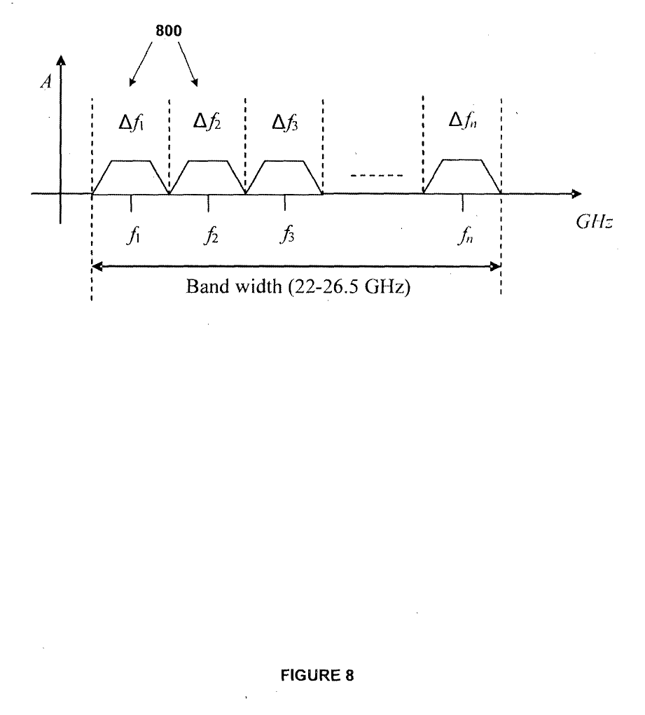

The reader 600 also uses the bandwidth of the allocated frequency band, as shown in FIG. 8. The bandwidth used to excite the tags 100, 200, 300, 400, 500 is a millimetre wave (mmW) band of 22 to 26.5 GHz, and is divided into a number of sub-bands 700 having centre frequencies f₁i=1−n. The RF transmitter 706 uses the sub-bands to transmit narrowband or ultra-wide band (UWB) pulses or bursts to provide interrogation signals in n iterations. After completing n iterations, the tag is read. Using the sub-bands improves the reading speed of the reader 600 when compared to a reader that may use a swept frequency reading method where continuous wave signals for each frequency are sent sequentially. Sub-band bursts of impulses improve the reading rate, and also reduce the noise that may affect the received signal if the entire frequency band is used. Using the sub-bands also provides a flat power spectral density across the bandwidth. The sub-band pulse transmission also assists in reducing the complexity of the signal processing and hardware of the reader 600.

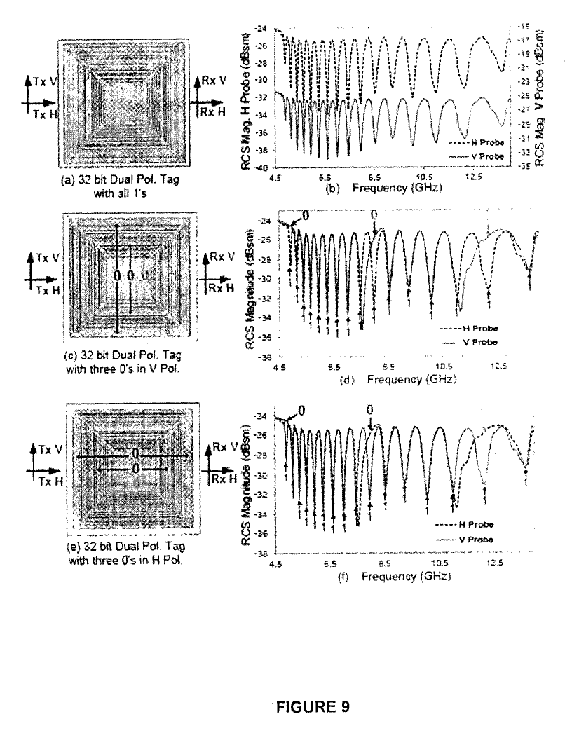

Frequency responses obtained from three different versions of the third tag 300, are shown in FIG. 9. FIG. 9(a) shows the response received for both the horizontal and vertical polarisations when all of the H slots and V slots are present in the tag so that the 32 bits of the tag are all 1. For FIG. 9(c), three pairs of V slots are omitted, and this shows how the absence of resonant peaks for those three pairs can be detected to represent three 0s. In FIG. 9(e), three of the H slots are omitted and the horizontal response shows the detection of three 0s.

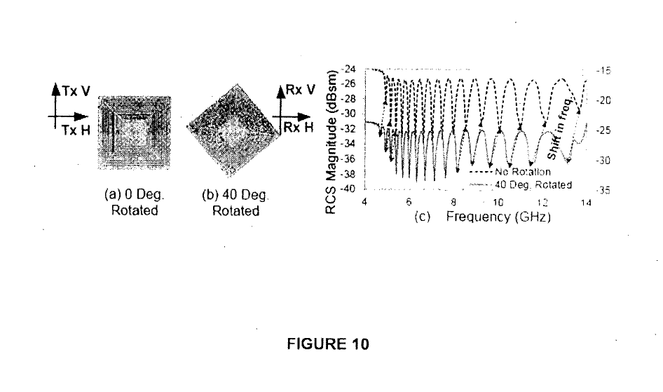

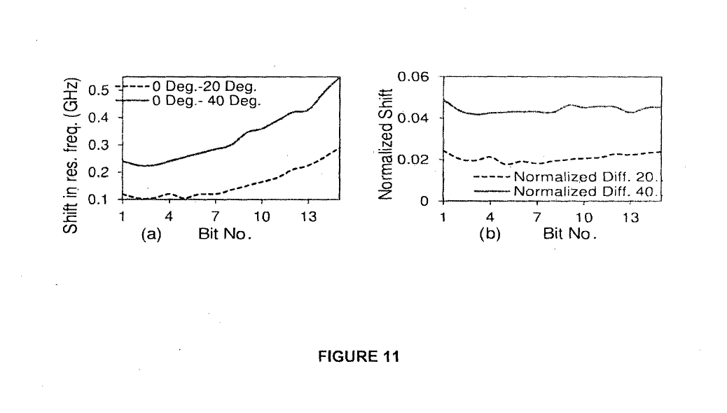

By replicating the absence of corresponding H and V slots, Lᵢ and Wᵢ, the tag becomes linearly polarised and rotation independent. However, without detecting any distinction between the H and V slots, the data capacity of the tag 300 is reduced by half. FIG. 10 illustrates the frequency response obtained from the tag 300 where H and V slots are replicated and the tag 300 has no rotation and is then rotated by 40°. Similar to that shown in FIG. 9(a), the response is the same. As is apparent in FIG. 10, however, there is a frequency shift, and this increases with an increase in resonant frequencies of the slots, as shown in FIG. 11(a) for the tag 300 orientated 20° and orientated 40°. When this frequency shift is normalised based on the resonant frequency, the shift is constant for all slots (or bits) of a particularly orientated tag, as shown in FIG. 11(b). The reader 600 is able to account for this by using one or two slots of the tag 300 that are retained as a reference so as to determine the amount of shill for that slot or bit, and then predict the shifts for the other slots (or bits). The DSP 712 of the reader 600 is able to apply a compensation factor so that the encoded bits can be correctly decoded and tags 300 of any orientation can be read.

Many modifications will be apparent to those skilled in the art without departing from the scope of the present invention. For example, the reader 600 and the tags 100, 200, 300, 400, 500 can be adjusted so as to communicate using near field communication (NFC) communication standards. The tags 100, 200, 300, 400 and 500 can also be read by security gates, such as RFID security gates, and also electromagnetic (EM) security gates used to read magnetic or EM strips affixed to items or assets.

1. A passive and chipless radio frequency identification (RFID) transponder comprising:
a substrate; and
at least one planar patch on the substrate, the patch including a slot resonator of with radial conductive strips disposed at points around the slot resonator.

2. The transponder as claimed in claim 1, wherein the strips have an air gap slots along their length.

3. The transponder as claimed in claim 1, wherein the slot resonator is circular.

4. The transponder as claimed in claim 1, wherein the slot resonator is polygonal and the radial conductive strips are disposed at the vertices of the slot resonator.

5. A passive and chipless radio frequency identification (RFID) transponder comprising:
a substrate; and
at least one planar patch on the substrate, the patch including parallel pairs of horizontal slot resonators in opposing quadrants and having lengths Lᵢ, i=1−n, that decrease towards the center of the patch: and parallel pairs of vertical slot resonators in opposing quadrants and having lengths Wᵢ, i=1−n, that decrease towards the center of the patch.

6. The transponder as claimed in claim 5, wherein the patch is symmetrical.

7. The transponder as claimed in claim 5, wherein the patch comprises a plurality of patches in an array.

8. A passive and chipless radio frequency identification (RFID) transponder comprising:
a substrate; and
a plurality of planar antennas with respective selected resonant frequencies, wherein each antenna includes a first portion in conductive communication with both a second portion and a third portion, and wherein the second portion and the third portion are separated by a non-conductive slot.

9. The transponder as claimed in claim 8, wherein the substrate is dielectric, and the patch is conductive or metallic.

10. A radio frequency identification (RFID) reader, comprising:
a transmit antenna configured to transmit RF interrogation signals to a passive and chipless RFID transponder;
a receive antenna configured to receive backscattered signals in response from the RFID transponder;
an RF module including an RF transmitter configured to generate the RF interrogation signals for the transmit antenna and an RF receiver configured to amplify and down convert the signals received by the receive antenna; and
a digital module including a digital controller configured to control the RF transmitter and a digital signal processor (DSP) configured to process the down converted signals from the RF receiver to extract a unique identification (ID) code of the RFID transponder.

11. The RFID reader as claimed in claim 10, wherein the digital module includes embedded computer program code to communicate with and control the digital controller and the DSP and communicate with a computer database system to provide the ID code.

12. The RFID reader as claimed in claim 10, wherein the transmit and receive antennas comprise beam forming smart antennas so as to beam steer the transmitted and received signals.

13. The RFID reader as claimed in claim 10, wherein the digital module includes control electronics to control the phase and amplitude distribution of the signals of the transmit and receive antennas.

14. The RFID reader as claimed in claim 10, wherein the transmitted interrogation signals frequencies are within a GHz frequency band that is divided into n transmission sub-bands to transmit narrow band or ultra-wide band (UWB) pulses to provide the interrogation signals in n iterations.

15. The RFID reader as claimed in claim 14, wherein the frequency band is 22 GHz to 26.5 GHz.

16. The RFID reader as claimed in claim 10, wherein the RFID transponder comprises a passive and chipless RFID transponder comprising: a substrate, and at least one planar patch on the substrate, the patch including a slot resonator of with radial conductive strips disposed at points around the slot resonator.

17. A reader for reading a transponder, wherein the transponder comprises a passive and chipless radio frequency identification (RFID) transponder comprising a substrate, and at least one planar patch on the substrate, the patch including a slot resonator of with radial conductive strips disposed at points around the slot resonator.
